(19) United States
(12) Patent Application Publication
(10) Pub. No.: US 2008/0198597 A1
(43) Pub. Date: Aug. 21, 2008

(54) Illumination Device

(75) Inventor: Simon Blumel, Schierling (DE)

Correspondence Address: FISH & RICHARDSON PC, P.O. BOX 1022, MINNEAPOLIS, MN, 55440-1022, US

(73) Assignee: OSRAM OPTO SEMICONDUCTORS GMBH, Regensburg (DE)

(21) Appl. No.: 12/064,899

(22) PCT Filed: Aug. 14, 2006
(86) PCT No.: PCT/DE2006/001421

§ 371 Date: Apr. 28, 2008

(30) Foreign Application Priority Data
Sep. 30, 2005 (DE) 10 2005 047 154.4
Dec. 21, 2005 (DE) 10 2005 061 208.3

(51) Int. Cl. F21V 7/00

(52) U.S. Cl. 362/247

(57) ABSTRACT

An illumination device is disclosed that is provided with a radiation exit surface, a reflector arrangement comprising a first reflector layer and a second reflector layer, and a radiation source, and in which the first reflector layer is disposed between the radiation exit surface and the radiation source, radiation generated by the radiation source radiates in part through the first reflector layer, and the second reflector layer is disposed on the opposite side of the first reflector layer from the radiation exit surface.

The present invention concerns an illumination device comprising a radiation source and a radiation exit surface.

In an illumination device of this kind, it is often desirable for the radiant power produced by the radiation source to have a laterally uniform distribution on the radiation exit side. In particular, the radiant exitance (watts of radiant power leaving an exit surface per m² of exit surface) should be distributed as uniformly as possible on the radiation exit side. A uniform distribution of irradiance (watts of radiant power striking the surface to be illuminated per m² of impingement area) on a surface to be illuminated by the illumination device can thus be obtained in a simplified manner.

The often limited spatial extent of the radiation source frequently makes it difficult to obtain a uniform radiant power distribution with a large-area radiation exit surface, whose area is greater than that covered laterally by the radiation source. In particular, regions of higher radiant power than the adjacent regions, so-called hot spots, can form on the radiation exit side, traceable to the regions that are illuminated directly by the radiation source. This is normally undesirable in applications that demand a uniform radiant power on the radiation exit side.

One object of the present invention is to specify an illumination device, particularly a planar illumination device, that facilitates the forming of a uniform distribution of the radiant power on a radiation exit surface of the illumination device in the lateral direction. An illumination device that is amenable to compact configuration will also be specified.

This object is achieved by means of an illumination device having the features of claim 1. Advantageous configurations of the invention are the subject matter of the dependent claims.

An illumination device according to the invention includes a radiation exit surface, a reflector arrangement comprising a first reflector layer and a second reflector layer, and a radiation source, wherein the first reflector layer is disposed between the radiation exit surface and the radiation source, radiation generated by the radiation source radiates in part through the first reflector layer, and the second reflector layer is disposed on the opposite side of the first reflector layer from the radiation exit surface.

The reflector arrangement is preferably configured such that the radiation striking the first reflector layer is in part designedly reflected away from the radiation exit surface.

A fraction of the radiation striking the first reflector layer at an oblique angle to the surface normal thereto is reflected away from the radiation exit surface at a corresponding angle. By being back-reflected by the second reflector layer, the radiation fraction reflected obliquely by the first reflector layer can strike the first reflector layer at a distance laterally from the impingement location of the first reflection on the first reflector layer and can pass through said layer or be reflected further by it. As a result of reflection by the first and second reflector layers, radiant power generated by the radiation source can therefore advantageously be distributed laterally uniformly on the first reflector layer and thus more simply also on the radiation exit surface by means of the reflector arrangement. To this end, the first and the second reflector layers are usefully disposed in spaced relation. Furthermore, the side of the first reflector layer facing away from the radiation source can form the radiation exit surface of the reflector arrangement or of the illumination device.

Via multiple reflection from the first reflector layer, regions comparatively remote from the radiation source in the lateral direction can advantageously also be illuminated by the radiation source. In particular, the radiation source can be disposed advantageously close to the first reflector layer, lateral distribution of the radiant power being effected by the reflector arrangement. This advantageously facilitates the creation of a small and compact illumination device having a very small thickness and thus a very small installation depth without compromising the lateral uniformity of the illumination.

The region illuminated on the radiation exit side can advantageously be increased in size over that of an illumination device not comprising a first reflector layer. Without a first reflector layer, the region of the to-be-illuminated area that is illuminated by the radiation source is determined by the radiation cone from the radiation source. Through the use of the reflector arrangement, the illuminated region can be increased in size—the radiation source being at the same distance from the area to be illuminated—as a result of (multiple) reflection by the reflector layers. As a result of this reflection, the first and the second reflector layers continue to contribute substantially to the homogenization of the radiant power distribution on the radiation exit surface of the illumination device.

The radiation source is preferably implemented as a separate radiation source. In particular, the reflector arrangement is preferably implemented as a separate arrangement and is not integrated into the radiation source. A large-area lighting device that is substantially independent of the dimensions of the radiation source can be realized more simply in this way.

In addition, the radiation source is not to be regarded solely as a laser-active gain medium in the context of the invention.

An illumination device of this kind is particularly suitable for backlighting, particularly directly backlighting, a display device, for instance a liquid crystal display (LCD), and is therefore preferably provided for this purpose. Direct backlighting, as opposed to indirect backlighting, is to be considered a relative arrangement of the radiation source and the area to be illuminated such that a main radiation direction of a radiation-generating element of the radiation source is aimed directly at the area to be illuminated. There is no need for onerous deflection of the radiation from the main radiation direction toward the area to be illuminated. With indirect backlighting, on the other hand, it is usually necessary for the radiation generated by the radiation source, which normally radiates primarily parallel to the area to be illuminated, to be deflected out of the main radiation direction toward the area to be illuminated.

Furthermore, the illumination device, particularly the reflector arrangement, is preferably configured and/or arranged to provide lateral illumination of the radiation exit surface. In particular, the illumination device can present a laterally uniform radiant exitance at the radiation exit surface.

It should be noted that the term lateral illumination is not necessarily to be understood as meaning complete illumination of the radiation exit surface. In particular, edge regions of the radiation exit surface need not necessarily be completely illuminated. However, the illuminated subregions of the radiation exit surface can preferably be uniformly illuminated in simpler fashion, by virtue of the reflector arrangement, than with a similar illumination device that does not include the first reflector layer or the reflector arrangement.

In a preferred configuration, the illumination device comprises a plurality of radiation sources, particularly separate radiation sources. The first reflector layer is preferably disposed between the radiation sources and the radiation exit surface. The illumination device can have for example 10 or more, preferably 50 or more, particularly preferably 100 or more radiation sources. The number of radiation sources is usefully governed by the suitable or necessary radiant power at the radiation exit surface for the application concerned. A plurality of radiation sources advantageously is not necessary for uniform illumination of the radiation exit surface, so the number of radiation sources used to uniformly illuminate the radiation exit surface is essentially independent of the size of the radiation exit surface.

By means of the reflector arrangement, the radiations generated by different radiation sources of the illumination device can be distributed laterally uniformly and mixed together by (multiple) reflection from the first and/or the second reflector layer. The occurrence of regions on the radiation exit surface or on the side of the first reflector layer facing the radiation sources that are illuminated at a higher or lower radiant power than laterally adjacent regions can be largely eliminated by means of the reflector arrangement. In illumination devices comprising a plurality of radiation sources, regions of this kind often occur in regions of the radiation exit surface that are laterally between the radiation sources.¹ A region of increased radiant power can be caused, for example, by an overlap of radiation cones from two radiation sources, whereas a region of decreased radiant power can be caused by a region that is not irradiated directly. By means of the reflector arrangement, the radiant power distribution on the first reflector layer or the radiation exit surface can be homogenized both in a region that is not directly irradiated and in a region of overlap of two radiation cones. 1 Translator's Note: The German actually reads, “often occur in regions of the radiation exit surface, which is disposed laterally between the radiation sources.” We assume that the intended meaning—relating to hot spots—is as we have it above.

In another preferred configuration, the first reflector layer completely covers the second reflector layer in the lateral direction and/or vice versa. This facilitates lateral beam guidance in the reflector arrangement between the first and the second reflector layer by multiple reflection.

In addition, the first and the second reflector layers preferably extend parallel to each other. The incident angles at which radiation that is being reflected back and forth between the first reflector layer and the second layer strikes a particular reflector layer are substantially equal if the reflector layers are in a parallel arrangement, thereby facilitating uniform illumination of the first reflector layer and thus of the radiation exit surface.

In another preferred configuration, the first reflector layer covers the radiation source or the radiation sources in the lateral direction. This facilitates the deliberate reflection of radiation generated by the radiation source or sources and emitted directly at the reflector layer.

In another preferred configuration, the reflector arrangement comprises a side reflector layer, which preferably extends from the first reflector layer to the second reflector layer. Particularly preferably, the side reflector layer extends from the first reflector layer just to the second reflector layer. The side reflector layer can extend vertically with respect to a lateral main direction of extension of the first reflector layer. A plurality of side reflector layers is preferably provided.

By means of the first reflector layer, the second reflector layer and the side reflector layer, a beam space can be formed on which the radiant power produced by the radiation source or sources is concentrated, particularly by means of the reflector arrangement. The first and the second reflector layer delimit the beam space preferably in the vertical direction. A plurality of side reflector layers can be provided if appropriate. This facilitates the creation of a beam space on which the radiant power produced by the radiation source(s) is concentrated. Particularly preferably, the side reflector layer(s) delimit(s) the beam space in the lateral direction.

Radiation reflected obliquely back and forth between the first and second reflector layers is distributed in the lateral direction. A multiply reflected radiation fraction could potentially exit the reflector arrangement on a side. By reflection from the side reflector layer, such a radiation fraction can be delivered for further reflection by the first or second reflector layer and can leave the illumination arrangement [sic] by the radiation exit surface. Such a radiation fraction advantageously is not lost for illumination purposes.

The beam space is preferably configured as substantially radiation-tight. The beam space can be bounded on all sides by reflective elements, such as the first reflector layer, the second reflector layer and the side reflector layer(s). This makes it easier to configure the beam space so that it is radiation-tight. To couple radiation into the beam space, a reflective element or a plurality of reflective elements can be gapped. A gap of this kind is preferably configured such that the losses of radiation caused by the escape from the beam space of radiation that has already been coupled into the beam space can be kept as low as possible by means of the gap. To this end, the gap usefully has a suitably small lateral extent, for example corresponding to the lateral extent of the radiation source. For example, for this purpose the radiation source can abut an edge of the gap and can preferably terminate circumferentially flush with the gap.

The side reflector layer also preferably extends substantially perpendicularly to the first reflector layer and/or the second reflector layer. Laterally uniform illumination of the radiation exit surface can be obtained in a simplified manner in this way. The incident angles at which radiation reflected back and forth between the first and second reflector layers, combined with reflection by the side reflector layer, strikes the first and the second reflector layer can thus be kept constant in a simplified manner, particularly if the first and second reflector layers are arranged in parallel.

In another preferred configuration, the side reflector layer is connected to the first reflector layer and/or the second reflector layer, or the side reflector layer is disposed against the first and/or the second reflector layer. This makes it easier to configure the beam space so that it is radiation-tight.

In another preferred configuration, the first reflector layer, the second reflector layer and/or the side reflector layer have a reflectivity of 90% or more, preferably of 95% or more, particularly preferably of 98% or more. This facilitates the concentration of radiant power on the side of the first reflector layer facing away from the radiation exit surface. Such reflectivities are suitable for creating a uniform distribution of radiant power on the radiation exit side. A reflectivity of 98% or more has proven especially advantageous. Since radiation is intended to pass through the first reflector layer, the first reflector layer usefully has a reflectivity of less than 100%. The second reflector layer and/or the side reflector layer can have a reflectivity of up to 99.9%, preferably 100%.

In another preferred configuration, the reflectivity of the second reflector layer and/or the reflectivity of the side reflector layer is higher than the reflectivity of the first reflector layer.

Radiation can thus be prevented in a simplified manner from leaving the beam space elsewhere than from the first reflector layer. Essentially all of the radiant power produced by the radiation source or sources and emerging from the illumination device preferably exits the beam space from the first reflector layer.

In another preferred configuration, an additional reflector layer is disposed on the opposite side of the second reflector layer from the first reflector layer. By means of the additional reflector layer, which preferably extends parallel to the second reflector layer, radiation passing through the second reflector layer can be reflected back toward the second reflector layer. Radiation exiting the beam space through the second reflector layer can thus in a simplified manner be coupled back into the beam space and delivered for reflection by the first reflector layer. Such an additional reflector layer can also be used in conjunction with the side reflector layer(s), if any. Configuring a reflector layer structure with a plurality of reflector layers eliminates the need to configure the particular reflector layer as a single layer whose reflectivity is increased by a specific amount over the reflectivity of the first reflector layer, since the reflector layer structure preferably has an overall reflectivity that is similarly increased in comparison to the reflectivity of the first reflector layer.

In another preferred configuration, the first reflector layer, the second reflector layer and/or the side reflector layer comprise(s) a metal or the particular layer is implemented as metallic, for example as a metallization or a metal foil. A metal-containing reflector layer is distinguished by a reflectivity that is virtually independent of impingement angle, which is especially advantageous for producing laterally uniform illumination. An alloy-based reflector layer is also be suitable for this purpose in some cases.

The particular reflector layer can, for example, be applied as metallization to a carrier body, i.e. vapor-deposited, or applied to the carrier body as reflective foil, particularly metal foil, i.e. laminated on. The carrier body stabilizes the reflector layer, preferably mechanically, and can be implemented as a light guide or a separate carrier element. The carrier body is preferably disposed between the first and the second reflector layer.

The carrier body preferably essentially does not serve to effect beam guiding, but instead simplifies the production of the reflector arrangement, since applying the particular reflector layer to the carrier body is simpler than separately constructing the reflector arrangement with a carrier body that mechanically supports the reflector layer(s). A carrier body can, for example, be disposed on the side of the particular reflector layer facing away from the beam space or the side facing toward the beam space.

In another preferred configuration, the radiation exit surface, the first reflector layer, the second reflector layer and/or the side reflector layer is/are implemented as planar, particularly uncurved. Such an illumination device is particularly suitable for uniform illuminating a planar surface, particularly one that extends parallel to the radiation exit surface.

In another preferred configuration, the ratio of the irradiance on the first reflector layer to the radiant exitance on the radiation exit surface is 0.2 or less, preferably 0.1 or less, particularly preferably 0.05 or less. In particular, the ratio of the irradiance to the radiant exitance on mutually coincident surface regions of the first reflector layer and the radiation exit surface can assume such values. The irradiance and the radiant exitance preferably behave in this manner over substantially the entire lateral extent of the radiation exit surface. The radiant power produced by the radiation source or sources is therefore preferably concentrated on the side of the first reflector layer facing toward the radiation source or sources. This being the case, the radiant power passing through the first reflector layer is laterally advantageously uniformly distributed.

The illumination device is usefully configured such that the radiant power passing through the first reflector layer is sufficient for the application concerned. The reflectivity of the first reflector layer or the number of radiation sources can be suitably adapted for this purpose. Care should be taken here that the reflectivity of the first reflector layer is high enough to ensure uniform illumination of the radiation exit surface.

In another preferred configuration, the first reflector layer, the second reflector layer and/or the side reflector layer is/are implemented in one piece. This eliminates any interfaces between individual reflector-layer pieces for the particular reflector layer, with the attendant risk of exit losses or undirected reflection in the region of the interfaces between reflector-layer pieces.

In another preferred configuration, the first reflector layer, the second reflector layer and/or the side reflector layer is/are implemented as a preferably uninterrupted layer that is reflective throughout. This prevents diminished reflectivity of the particular reflector layer in the vicinity of an interruption.

In another preferred configuration, the first reflector layer, the second reflector layer and/or the side reflector layer has a reflectivity that is consistent, preferably constant, over its extent. This facilitates consistent reflection in substantially all regions of the particular reflector layer.

In another preferred configuration, the lateral extent of the first reflector layer and/or of the second reflector layer is greater than the vertical extent of the side reflector layer or each of the side reflector layers. A large-area radiation exit surface can thus be obtained in a simplified manner in combination with the small installation depth of the illumination device brought about by the relatively small vertical extent of the side reflector layer.

The area content of the first reflector layer and/or of the second reflector layer is preferably greater than that of the side reflector layer, or greater than that of each of the side reflector layers or that of the side reflector layers combined. This further facilitates a small, compact configuration for the illumination device in combination with a large radiation exit surface.

In a further preferred configuration, the second reflector layer comprises a gap or a plurality of gaps. The gap is preferably configured or provided as throughpass opening for radiation through the second reflector layer or as an insertion opening for the insertion of a radiation source.

In particular, a radiation-generating element of the radiation source can thus be disposed in simpler fashion on the side of the second reflector layer facing away from the first reflector layer. The radiation generated by this element can pass through the region of the second reflector layer by way of the gap, without being reflected by the second reflector layer, and impinge on the first reflector layer.

In another preferred configuration, a common gap is associated with a plurality of radiation sources. Radiation generated by a plurality of radiation sources consequently passes through the region of the second reflector layer through a common gap.

In another preferred configuration, each radiation source is associated with its own discrete gap. This makes it easier to shape the gap in a manner adapted to the particular radiation source.

This reduces the risk of exit losses, compared to the use of a common gap for a plurality of radiation sources, since with a plurality of discrete radiation sources the individual radiation sources often have to be spaced apart from each other, for example due to assembly constraints, so the area of the gap is often greater than that which is strictly necessary for the passage of radiation. The area that is not needed for the passage of radiation but is nevertheless gapped increases the likelihood, however, that radiation will pass through the second reflector layer after being reflected by the first reflector layer. Such penetrating radiation may be lost for illumination purposes. Nevertheless, a common gap for a plurality of radiation sources may, in some cases, be easier to fabricate than discrete gaps, one for each radiation source.

The radiation source or the plurality of radiation sources preferably engages in the gap or the plurality of gaps. A small and compact illumination device can be realized more simply in this way.

The exiting of radiation from the beam space as a result of the penetration of radiation through the gap to the side of the second reflector layer facing away from the first reflector layer can advantageously be reduced by implementing the gap and the radiation source engaging in it in a mutually adapted manner. For example, an edge of the gap can enter into frictional engagement with the radiation source.

In another preferred configuration, the radiation source has an outcoupling surface through which the radiation generated in the radiation source leaves the radiation source. When a plurality of radiation sources is present, they have, particularly each one has, an outcoupling surface through which the radiation generated in the radiation sources leaves the radiation sources.

In another preferred configuration, the outcoupling surface or a plurality of outcoupling surfaces is arranged between the first reflector layer and the second reflector layer. Radiation can thus be outcoupled from the radiation source between the first and second reflector layers.

The outcoupling surface can, for example, be led through the second reflector layer via the gap in the second reflector layer.

A radiation generating element of the radiation source can in this case be disposed on the opposite side of the second reflector layer from the first reflector layer. The outcoupling surface can be disposed on the side of the second reflector layer facing toward the first reflector layer. The outcoupling surface preferably terminates with the second reflector layer or is disposed between the first and the second reflector layer and in spaced relation to the second reflector layer. In this way, substantially all of the radiation generated by the radiation source is coupled out of the radiation source on the side of the second reflector layer facing toward the first reflector layer.

Alternatively, the outcoupling surface can be disposed on the side of the second reflector layer facing away from the first reflector layer. In this case, the generated radiation from the first reflector layer is delivered for reflection through a gap in the second reflector layer. Such an arrangement may in some cases be easier to implement than the above arrangement. However, the installation depth of the illumination device is increased in comparison to the above arrangement.

In another preferred configuration, the radiation source or a plurality of radiation sources generates radiation between the first and the second reflector layer. A radiation generating element of the radiation source can thus be disposed between the first and the second reflector layer. This facilitates the creation of a small and compact illumination device. Where appropriate, the second reflector layer, on which the radiation source is preferably disposed in this case, can also serve to electrically contact the radiation source. For this purpose, the reflector layer is preferably implemented as electrically conductive or is provided with electrically conductive contact structures for electrically contacting the radiation source.

In another preferred configuration, a distance from the outcoupling surface or a plurality of outcoupling surfaces to the radiation exit surface and/or to the first reflector layer is 5 mm or less, preferably 2 mm or less, particularly preferably 1 mm or less. Such an arrangement of the outcoupling surface(s) relative to the first reflector layer facilitates the creation of a small and compact illumination device.

In arranging the outcoupling surface relative to the first reflector layer, care should be taken not to unnecessarily reduce the fraction of radiation that is incident obliquely to the surface normal of the first reflector layer. A decrease in this angularly incident radiation fraction would increase the number of reflections from the first and second reflector layers needed to produce uniform lateral illumination of an area of defined size. This can be prevented by arranging the outcoupling surface(s) of the radiation source(s) so that they are spaced apart from the first reflector layer. This spacing is preferably greater than or equal to 0.7 mm.

In another preferred configuration, the radiation source is provided to generate visible radiation.

In another preferred configuration, one or a more of the radiation sources is implemented as a radiation emitting diode. A radiation emitting diode is particularly suitable as a radiation source for a compact illumination device because of its long life and its lower space consumption than conventional radiation sources such as incandescent lamps or fluorescent tubes.

The radiation emitting diode can comprise an organic radiation generating element, as in the case of an OLED (organic light emitting diode), or an inorganic radiation generating element, preferably a semiconductor chip, for example a semiconductor chip based on a III-V semiconductor material, as in the case of an LED (light emitting diode). III-V semiconductor materials are particularly suitable for a semiconductor chip of the illumination device, owing to the high internal quantum efficiency that can be attained.

The radiation emitting diode is preferably configured as an optoelectronic component, particularly a surface-mountable optoelectronic component. Space-saving surface mounting technology (SMT) facilitates compact implementation of the illumination device.

In another preferred configuration, radiation generated in the radiation source passes through an optical element, e.g. a lens, particularly before striking the first reflector layer for the first time. The optical element is preferably disposed between the first reflector layer and the radiation generating element of the radiation source.

By means of the optical element, the radiation generated in the radiation source can be shaped according to a defined emission characteristic on the radiation exit side of the optical element. In particular, the optical element can be implemented such that an area illuminated by the radiation source, particularly an area of the first reflector layer, is irradiated at a irradiance that is uniform in the lateral direction on said area. The optical element, by beam shaping, preferably broadens the radiation characteristic of the radiation source as compared to a radiation characteristic of the radiation source without a ready optical element. The area of the first reflector layer that is directly illuminated by the radiation source is advantageously increased as a result.

Discrete optical elements that are each associated with a single radiation source are especially suitable for efficient beam shaping.

In another preferred configuration, the surface of the optical element comprises on the radiation exit side, particularly on the side facing toward the first reflector layer, a concavely curved subregion and a convexly curved subregion that surrounds the concavely curved subregion, particularly laterally. An optical axis, which may pass through the radiation generating element of the radiation source, preferably passes through the concavely curved subregion. The convexly curved subregion is preferably at a distance from the optical axis. In addition, the optical element, particularly the optical functional areas thereof, is preferably implemented as rotationally symmetrical with respect to the optical axis.

With shaping of this kind, a broadening, particularly a symmetrical broadening, of the radiation characteristic can be achieved in a simplified manner, the irradiance being laterally distributed advantageously uniformly on the area to be illuminated, particularly a planar such area.

Inhomogeneities in the radiant power distribution on the directly illuminated area of the first reflector layer can be avoided. A rotationally symmetrical implementation is particularly suitable for this purpose.

Due to the broadening of the radiation characteristic of the radiation source by means of the optical element, the distance of the outcoupling surface of the radiation source from the first reflector layer can advantageously be kept very small without sacrificing any of the uniformity of illumination of the first reflector layer.

In another preferred configuration, the optical element is attached to the radiation source as a separate optical element. The outcoupling surface of the radiation source can be formed in this case by a radiation exit surface of the optical element. The beam forming by the optical element then takes place in advantageous proximity to the radiation generating element of the radiation source.

The optical element can be, for example, glued to the radiation source, or it can be mated to the radiation source, for example by means of a plurality of dowel pins preferably provided on the optical element.

Other features, advantages and utilities of the invention will emerge from the following description of the exemplary embodiments taken in conjunction with the figures.

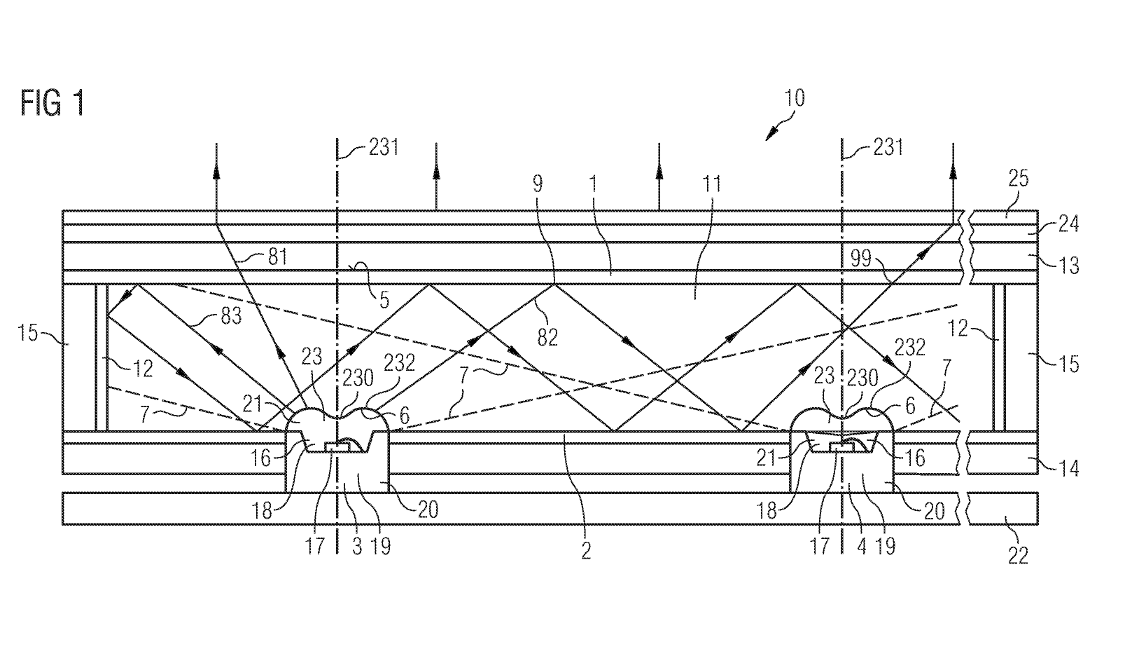

FIG. 1 shows a first exemplary embodiment of an illumination device according to the invention in schematic sectional view,

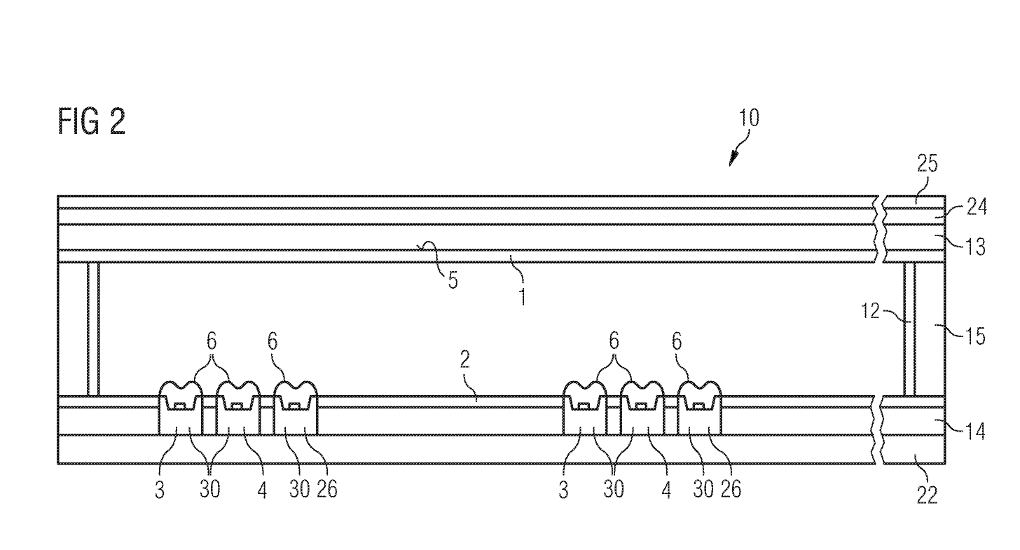

FIG. 2 shows a schematic sectional view of a second exemplary embodiment of an illumination device according to the invention,

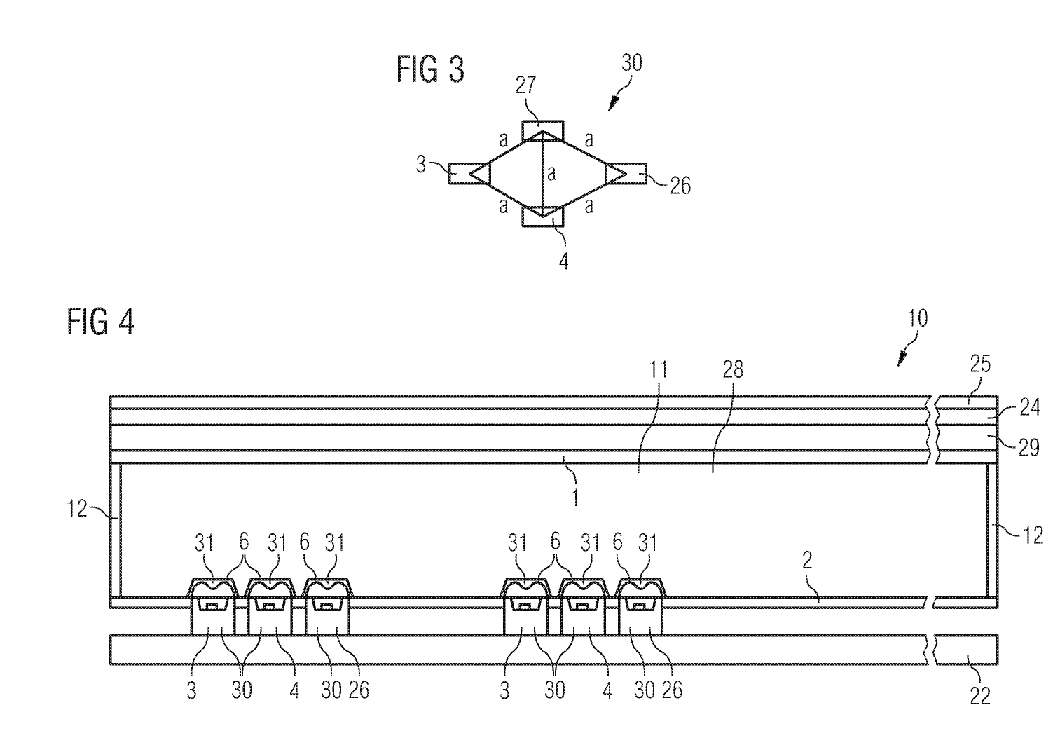

FIG. 3 shows an arrangement of radiation sources that is particularly advantageous for an illumination device,

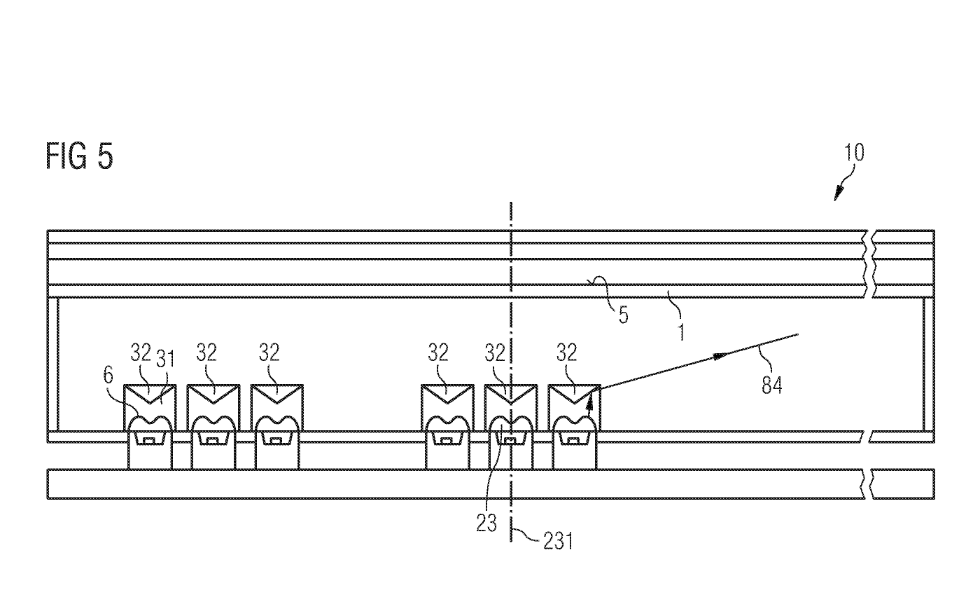

FIG. 4 shows a schematic sectional view of a third exemplary embodiment of an illumination device according to the invention and

FIG. 5 shows a schematic sectional view of a fourth exemplary embodiment of an illumination device according to the invention.

Like, similar and like-acting elements are provided with the same reference characters in the figures.

FIG. 1 shows a first exemplary embodiment of an illumination device 10 according to the invention in schematic sectional view.

The illumination device 10 comprises a reflector arrangement, having a first reflector layer 1 and a second reflector layer 2, and a plurality of radiation sources. In the exemplary embodiment according to FIG. 1, a first radiation source 3 and a second radiation source 4 of the illumination device are illustrated. A different number of radiation sources, for instance a higher number, can also be provided. The number of radiation sources installed in the illumination device is usefully governed by the radiant power needed for the particular application, or, expressed as the corresponding photometric value that factors in the sensitivity of the human eye, by the necessary luminous flux.

The illumination device 10 further comprises a radiation exit surface 5. First reflector layer 1 is disposed between the radiation exit surface 5 and the radiation sources 3 and 4. The radiation exit surface 5 can be constituted, for example, by the surface of first reflector layer 1 that faces away from the radiation sources. Alternatively, the radiation exit surface can, where appropriate, be formed by the surface facing away from the radiation sources of an element of the illumination device that is disposed on the side of the first reflector layer facing away from the radiation sources.

The second reflector layer 2 is disposed on the opposite side of the first reflector layer 1 from radiation exit surface 5.

The behavior in the illumination device of radiation generated in the radiation sources is illustrated by way of example in FIG. 1, in the form of the beam paths of the radiation fractions 81, 82 and 83 generated by first radiation source 3.

Radiation leaves radiation sources 3 and 4 via an outcoupling surface 6 of the particular radiation source. The cone of radiation from each radiation source is bounded by the corresponding lines 7 indicated in broken form. In the case at hand, the respective radiation cones from first radiation source 3 and second radiation source 4 overlap on first reflector layer 1.

Despite the overlap on the first reflector layer, a uniform radiant power distribution the radiation exit side can be obtained by the reflection of radiation from the first and second reflector layers. The same applies to spaced-apart, non-overlapping radiation cones.

A radiation fraction 81 leaving first radiation source 3 via its outcoupling surface 6 strikes first reflector layer 1, particularly directly and/or obliquely, and passes on through it.

Another radiation fraction 82 of the radiation generated by first radiation source 3 strikes first reflector layer 1 obliquely and is reflected there. After being thus reflected, radiation fraction 82 strikes the second reflector layer, is reflected there back to the first reflector layer, strikes it, and passes on through first reflector layer 1. A first point of incidence 9 of radiation fraction 82 on the first reflector layer is at a distance laterally from a second point of incidence 99 of this radiation fraction on the first reflector layer. Second point of incidence 99 is in particular a greater distance laterally from radiation source 3 than first point of incidence 9.

The radiation generated by the radiation sources therefore passes in part through the first reflector layer, in some cases after being reflected multiple times by the first and second reflector layers. At the same time, a portion of the radiation is designedly reflected away from the radiation exit surface 5 by first reflector layer 1.

The reflection of radiation fractions of the radiation generated by the first radiation source at first reflector layer 1 and/or second reflector layer 2 thereby serves to produce a uniform lateral distribution of the irradiance—measured in lumens of the luminous flux generated by the radiation source and striking the first reflector layer per square meter of area of impingement on the first reflector layer—on the side of the first reflector layer 1 facing toward the radiation sources. In particular, regions of the first reflector layer that are not illuminated directly by the radiation source 3 can also be illuminated by reflection—multiple reflection, where necessary—from the first and/or the second reflector layer. The same applies to the radiation generated by the second radiation source 4. In particular, a portion of the radiations generated by the radiation sources is designedly reflected away from the radiation exit surface 5 by first reflector layer 1, such that preferably a set fraction of radiation passes through the first reflector layer. This fraction is then available for the particular lighting application.

The radiant power passing through the first reflector layer is advantageously uniformly distributed on the radiation exit surface 5. The illumination device can therefore be characterized by a laterally particularly uniformly distributed radiant exitance, stated in lumens of luminous flux exiting the illumination device per square meter of exit surface. In particular, the occurrence of hot spots of increased radiant power on the radiation exit surface 5 can be prevented in a simplified manner by means of the reflector arrangement. Moreover, an area that is to be illuminated by means of the illumination device can be illuminated at a substantially laterally constant irradiance in a simplified manner.

The first reflector layer 1 and the second reflector layer 2 almost completely cover each other in the lateral direction. The first reflector layer 1 also covers the radiation sources in the lateral direction. The first and second reflector layers further preferably extend parallel to each other.

A beam space 11 is configured between the first reflector layer 1 and the second reflector layer 2 and [is] preferably bounded [thereby] in the vertical direction². In the lateral direction, i.e. the main direction of extension of the first reflector layer, the beam space 11 is bounded by one or more side reflector layers 12. Radiant power generated by the radiation sources can be concentrated on the beam space by the first and second reflector layers and the side reflector layers. The beam space is preferably configured as substantially radiation-tight, i.e., radiation generated by the radiation sources leaves the beam space substantially only via the area provided for this purpose, which in the present exemplary embodiment is first reflector layer 1. The side reflector layers 12 prevent any sideward, lateral outcoupling of radiation from the beam space 11. 2 Translator's Note: The words in brackets are our inference.

This is illustrated by radiation fraction 83, which is first reflected by first reflector layer 1, then strikes side reflector layer 12 and is in turn reflected by it in the direction of second reflector layer 2. If side reflector layer 12 were not present, then radiation fraction 83 would leave the beam space 11. This would mean an undesirable decrease in radiant power in the beam space and thus in the radiant power exiting via radiation exit surface 5. Second reflector layer 2 reflects radiation fraction 83 back in the direction of first reflector layer 1. Radiation fraction 83 can either be reflected further by first reflector layer 1, or it can pass on through it.

The side reflector layers 12 preferably extend in the vertical direction from first reflector layer 1 to second reflector layer 2. Particularly preferably, the side reflector layer extends [singular sic] perpendicularly to the first and second reflector layers. The side reflector layers 12 are also preferably directly disposed on or attached to the first and/or the second reflector layer. This facilitates the creation of a light-tight beam space 11. The individual reflector layers can, for example, be joined together, such as by adhesive bonding.

First reflector layer 1, second reflector layer 2 and side reflector layers 12 preferably have a reflectivity of 90% or more, particularly preferably of 95% or more, for example of 98% or more. To achieve this, these reflector layers preferably contain a metal or are implemented as metallic. So that the bulk of the radiation exits via the first reflector layer, the second reflector layer and the side reflector layers preferably have a higher reflectivity than the first reflector layer, e.g. of up to 100%. Configuring the reflector layer(s) as metal-containing, e.g. alloy-based or metallic, such as in the form of metallization or metal mirror foil, is particularly suitable for an illumination device 10.

First reflector layer 1 and the side reflector layer(s) is (are) preferably implemented as uninterrupted and as reflective throughout. These reflector layers preferably have a substantially constant reflectivity over their extent, so that regardless of the point of incidence of radiation on the first reflector layer, constant fractions of radiation are reflected and constant fractions of radiant power are able to pass through the first reflector layer.

The first reflector layer is preferably disposed on and/or attached to a first carrier element 13, the second reflector layer is preferably disposed on and/or attached to a second carrier element 14, and/or side reflector(s) 12 is (are) preferably disposed on and/or attached to third carrier elements 15. Each side reflector layer 12 is preferably associated with a respective discrete carrier element 15. The carrier elements 13, 14 and 15 can, for example, form part of a housing of the illumination device. The respective reflector layers can be applied to the respective carrier elements, for instance by being glued, laminated or vapor deposited thereon.

The first carrier element 13 of first reflector layer 1 is preferably disposed on the side of the first reflector layer facing away from radiation sources 3 and 4. First carrier element 13 is usefully configured as transparent to the radiation generated by the radiation source. Where appropriate, to further increase the uniformity of the radiant power distribution of the radiation passing through the carrier element, the first carrier element can be configured as a diffuser element, for instance a diffuser plate, e.g. of Plexiglas. The second or third carrier element can be implemented as absorbing, since it essentially does not serve to transmit radiation and the particular reflector layer carried by it is highly reflective.

The ratio of the irradiance on the side of first reflector layer 1 facing toward the radiation sources to the radiant exitance on the radiation exit surface is 0.2 or less, preferably 0.1 or less, particularly preferably 0.05 or less. This can be achieved by means of the above-cited high reflectivities of 98% or more.

Surprisingly, despite this high concentration of radiant power in the beam space 11, a radiant power exiting the illumination device can be obtained that is uniformly distributed on the radiation exit side and is suitable for backlighting a display device, such as an LCD, while at the same time the illumination arrangement [sic] can be configured as especially compact due to the lateral distribution of the radiant power by means of the reflector arrangement.

The illumination device is preferably configured as cuboid.

The second reflector layer 2, which is preferably configured in one piece, comprises a plurality of gaps 16 in which the radiation sources 3, 4 engage. The radiation sources can, in particular, engage in the gap in such a way that the outcoupling surfaces 6 of the radiation sources terminate with the surface of the second reflector layer that faces toward the first reflector layer. This ensures that substantially all of the radiation leaving the radiation source will be outcoupled from the radiation source between the first and the second reflector layer. The number of gaps 16 is preferably equal to the number of radiation sources, thereby preventing radiation losses resulting from radiation passing through a gap not occupied by a radiation source. The gaps 16 preferably also extend through the carrier element 14 bearing the second reflector layer. Each radiation source preferably is associated with its own, discrete gap. In addition, the gaps are preferably adapted to the radiation sources such that the radiation sources terminate laterally at the respective gaps, for example in a friction-locking manner.

To seal the beam space 11 against the passage of radiation through the side reflector layers 12 and/or the second reflector layer 2, an additional reflector layer, particularly respective reflector layers, can optionally be disposed on the side of the side reflector layers or of the second reflector layer facing away from the beam space. Such an additional reflector layer is not explicitly represented in FIG. 1, but can be disposed between the illustrated reflector layers and the particular carrier element.

In a simplified manner, individual reflector layers of the same kind can thus be used for a reflector layer structure that includes the particular reflector layer[s]—side reflector layer(s) or a second reflector layer—and a corresponding additional reflector layer, and the first reflector layer, it being possible when configuring the first reflector layer to leave out an additional reflector layer, so that radiation can exit in simpler fashion via the first reflector layer.

The distance of the outcoupling surface 6 of the radiation sources 3 and 4, respectively, from the first reflector layer is preferably 5 mm or less, particularly preferably 2 mm or less, for example 1 mm or less. This facilitates the creation of a small and compact illumination device. A distance greater than 0.7 mm is further particularly preferred.

The radiation sources 3 and 4 of the illumination device 10 are preferably implemented as radiation emitting diodes. Particularly preferably, the radiation emitting diodes are implemented as light emitting diodes for generating visible radiation. The radiation emitting diodes in this case preferably each comprise a semiconductor chip 17 provided to generate radiation. This semiconductor chip can be disposed in a cavity 18 of a housing body 19, for example containing a synthetic material, of a radiation emitting diode component 20. In addition, the semiconductor chip is preferably embedded in an envelope 21, e.g. containing a resin or a silicone, that protects it against harmful external influences. A surface-mountable radiation emitting diode component is particularly suitable for a small and compact illumination device. For the sake of simplicity, the electrical leads of the radiation emitting diodes have not been illustrated in FIG. 1.

Furthermore, the radiation sources can be disposed on a radiation source carrier 22, which preferably stabilizes the radiation sources mechanically. The radiation source carrier can in particular form the back wall of a housing of the illumination device. In the case of radiation emitting diode components, the radiation source carrier is preferably implemented as a circuit board, which can serve the purpose of electrically contacting the components. Otherwise than as shown, the radiation source carrier 22 can also be disposed directly on the second carrier element 14 or, if appropriate, attached thereto. Surface mountable radiation emitting diode components (SMDs or surface mountable devices) are particularly suitable for a compact illumination device.

To illuminate the first reflector layer, semiconductor chips can, if appropriate, also be mounted directly on the second reflector layer, which is then preferably implemented accordingly as electrically conductive and particularly preferably as a chip carrier, and can be electrically contacted by means of the second reflector layer. In this case, radiation is generated between the first and the second reflector layer. The radiation source can be formed substantially by the semiconductor chip.

Radiation generated in the radiation sources 3 and 4 passes through an optical element 23, particularly before striking the first reflector layer 1 of the reflector arrangement preferably directly or for the first time.

If radiation emitting diodes are used as radiation sources, the optical element 23 can be configured as integrated into the diode, for example by suitable shaping of the envelope 21, as illustrated exemplarily by radiation source 3, or the optical element can be disposed on a radiation emitting diode component and/or attached thereto as a separate optical element, as illustrated exemplarily by radiation source 4.

The optical element can, for example, be mated or glued to the radiation emitting diode. Suitable fastening devices are preferably configured for this purpose in the housing body and/or on the optical element. For the sake of simplicity, these are not explicitly shown.

A particularly suitable radiation source for the illumination device, comprising an optical element that can be attached to a radiation emitting diode and is particularly suitable for broadening the radiation characteristic of the radiation emitting diode and for uniform illumination, is described in more detail in Patent Application DE 10 2005 020 908.4, whose disclosure content is hereby explicitly incorporated into the present patent application.

In addition to two electrical leads for contacting the semiconductor chip, this radiation emitting diode has a separate thermal connecting part, which can be connected, for example to a heat sink, separately from the electrical connecting parts. As a high-output radiation emitting diode, this radiation emitting diode is particularly suitable for lighting applications.

As radiation emitting diodes, components having the following type designations from the manufacturer Osram Opto Semiconductors GmbH, or related components, are also suitable as radiation sources for an illumination device: LB A670, LB W5SG.

The last-named component is described in more detailed fashion for example in the patent application WO 02/084749, whose disclosure content is hereby explicitly incorporated by reference into the present application. This component is particularly suitable for generating high radiant powers. Moreover, the housing body of this component has a relatively large, freely accessible surface that simplifies the provision of fastening devices for an optical element, so an optical element can more easily be attached to it, e.g. mated to it by means of dowel pins provided on the optical element.

The surface of the optical element 23, which is implemented for example as a lens, preferably has on the radiation exit side a concavely curved subregion 230, through which, particularly preferably, an optical axis 231 passes. The optical axis 231 also preferably passes through the radiation source, particularly the semiconductor chip 17.

The optical element 23, particularly its radiation exit surface, further preferably has a convexly curved subregion 232 that laterally surrounds, particularly is concentric with, the concavely curved subregion, particularly at a distance from the optical axis 231. The radiation exit surface of the optical element preferably forms the outcoupling surface 6 of the radiation source.

Shaping the optical element 23 in this manner makes it possible advantageously to broaden the radiation characteristic of the radiation source compared to the unmodified radiation characteristic of the radiation generating element of that radiation source, e.g. of the semiconductor chip. Imparting a curvature to the radiation exit surface causes radiation to be refracted away from the optical axis on the radiation exit side. This advantageously increases the size of the region of the first reflector layer that is illuminated directly by the radiation source, while allowing a prescribed distance to be maintained between the radiation exit surface of the optical element and the first reflector layer. Conversely, given a prescribed area for the to-be-illuminated subregion of the first reflector layer, the radiation source can with greater simplicity be disposed closer to the first reflector layer, due to the broadening of the radiation characteristic by the optical element. Thus, more radiation strikes the first reflector layer at large angles with the surface normal thereto. This results in increased reflection from the first reflector layer at relatively large angles, making it possible to obtain uniform lateral illumination in a simplified manner.

The optical element 23 is preferably configured such that the irradiance is laterally uniformly distributed on that subregion of the, particularly planar, first reflector layer 1 which is illuminated by the radiation source. To this end, the optical element 23 is particularly preferably configured as rotationally symmetrical with respect to the optical axis 231. In addition, the optical axis 231 preferably extends parallel to the surface normal of the first reflector layer. This facilitates uniform direct illumination of the first reflector layer 1.

Overall, preshaping the radiation characteristic of the radiation source by means of the optical element 23 and (multiple) reflections in the beam space 11 of the reflector arrangement achieves the effect of producing a uniform radiant exitance from the illumination device on the radiation exit side, said illumination device at the same time being amenable to small and compact construction.

Furthermore, an illumination device according to the invention facilitates the uniform planar illumination of an area to be illuminated that is disposed on the radiation exit surface side. Such a device can be used, for example, for display devices with a surface diagonal of up to 57″. Even display devices having a larger surface diagonal, particularly of the radiation exit surface, can be implemented more simply and, in particular, compactly by means of the illumination device.

To align the radiation exiting from the radiation exit side and/or through the first carrier element 13 so that it is parallel to the surface normal of the radiation exit surface 5, a layer structure 24 can be disposed on the side of the first reflector layer facing away from the radiation sources. Such a layer stack is also known as a brightness enhancement film (BEF), since the brightness perceived by an observer in the vicinity of the surface normal is increased by means of the layer structure. The contrast can be enhanced in this way. A D-BEF (double BEF) is particularly suitable as a brightness enhancement film.

The layer structure 24 preferably includes a plurality of individual layers, which for the sake of simplicity are not explicitly illustrated here. Radiation generated by the radiation source and passing through the first reflector layer, preferably after transiting the first carrier element and/or the layer structure 24, strikes a display device 25 that is to be backlit, e.g. an LCD, which preferably is integrated along with the layer structure into the layer composite disposed on the first reflector layer and particularly preferably terminates the layer composite.

Illustrated in FIG. 2 is a schematic sectional view of a second exemplary embodiment of an illumination device according to the invention.

The exemplary embodiment according to FIG. 2 is substantially the same as that illustrated in FIG. 1. As distinct from that embodiment, here the radiation source carrier 22 is disposed directly on the second carrier element 14 and is preferably attached thereto.

In addition, the illumination device according to FIG. 2 comprises a plurality of beam units 30, which in turn comprise—particularly, each of which comprises—a plurality of radiation sources. A beam unit 30 here comprises a first radiation source 3, a second radiation source 4 and a third radiation source 26. The radiation sources of a beam unit preferably generate, particularly in pairs, different-colored radiations. For example, the first radiation source 3 generates radiation in the red region of the spectrum, the second radiation source 4 radiation in the green region of the spectrum, and the third radiation source 26 radiation in the blue region of the spectrum. Different-colored radiations can thus be generated by means of one beam unit 30. A beam unit can also, in particular, generate mixed-color radiation, particularly white light, by driving a plurality of radiation sources simultaneously. The beam path has not been shown explicitly in FIG. 2. The radiation sources of a beam unit are preferably arranged laterally adjacent one another, particularly in groups.

The distance of the outcoupling surfaces 6 of the radiation sources from the first reflector layer 1 can be, for example, 3.5 mm. The first carrier element 13 can be implemented for example as a diffuser, for example 3 mm thick, made, for example, of Plexiglas. The distance between the first reflector layer 1 and the second reflector layer 2 can be, for example, 5 mm. The third carrier elements 15, which preferably determine this distance or are configured as spacers, are implemented accordingly, e.g. with a height of 5 mm. The reflector layers can, for example, each have a reflectivity of 98%. The overall thickness of such an illumination device 10 can be 10 mm or less. An illumination device of this kind is able to deliver a luminance on the radiation exit side that is equivalent to a luminance used for backlighting conventional display devices.

A very uniform radiant power distribution was obtained at the radiation exit side with a test illumination device according to FIG. 1 or 2, particularly configured as cuboid, having a radiation exit surface that was square in plan and measured 100 mm×120 mm, and equipped with two radiation emitting diodes arranged 70 mm apart on a diagonal of the base of the cuboid. The individual light sources could no longer be differentiated at the exit side.

FIG. 3 is a schematic representation of an arrangement of the radiation sources of a beam unit, said arrangement being particularly advantageous for an illumination device.

The beam unit 30 preferably comprises a first radiation source 3, a second radiation source 4, a third radiation source 26 and a fourth radiation source 27. The radiation sources are preferably implemented as radiation emitting diodes. In particular, the radiation is generated in the radiation sources preferably by means of optoelectronic semiconductor chips. Radiation source 4 is preferably configured to generate radiation in the red region of the spectrum, radiation sources 3 and 26 to generate radiation in the green region of the spectrum, and radiation source 27 to generate radiation in the blue region of the spectrum. Two radiation sources of one beam unit can thus be configured to generate radiation of the same color, particularly radiation having the same peak wavelength, e.g. green radiation.

A rhomboid arrangement of the four radiation sources of the beam unit has proven especially suitable for an illumination device, particularly a planar illumination device. With the exception of radiation sources 3 and 26, adjacent radiation sources preferably have the same spacing “a”.

This arrangement is particularly suitable for generating uniform mixed-color light by means of the beam unit, to illuminate the first reflector layer. A spacing “a” of approximately 10 mm has proven especially advantageous.

The illumination device preferably also includes a plurality of beam units, individual beam units particularly preferably being arranged on the grid points of a two-dimensional hexagonal grid. The individual radiation sources are preferably arranged in groups around the particular grid point.

FIG. 4 is a schematic sectional view of a third exemplary embodiment of an illumination device according to the invention.

The exemplary embodiment according to FIG. 4 is substantially the same as that illustrated in FIGS. 1 and 2; here again, units 30 whose radiation sources are able to generate different-colored radiation are used (see also FIGS. 2 and 3). In contrast to the previous figures, in the exemplary embodiment according to FIG. 4 there are no carrier elements 13, 14 and 15.

In the exemplary embodiment according to FIG. 4, in further contrast to the previously described exemplary embodiments, a light guide 28 is disposed between the first reflector layer 1 and the second reflector layer 2. In particular, the beam space 11 can be essentially formed by said light guide 28.

First reflector layer 1, second reflector layer 2 and/or side reflector layers 12 are preferably disposed or configured on the corresponding surfaces of the light guide. Preferably at least one of these reflector layers, particularly preferably all of them, is/are applied to the light guide 28, for example vapor-deposited or laminated thereon. For example, a metallization can be formed on the light guide 28, for example by vapor deposition, or a mirror foil can be laminated onto the light guide. This advantageously eliminates the need to provide additional carrier elements for the reflector layers.

A diffuser element 29 is disposed on the side of the first reflector layer facing away from the radiation sources 3, 4 and 26. In contrast to carrier element 13 according to FIG. 1 or 2, the diffuser element advantageously does not assume any mechanical load-bearing function for the first reflector layer 1. Instead, the light guide disposed between the first and second reflector layers is able to sustain the first reflector layer and preferably also the other reflector layers.

In the light guide, on the side facing the radiation source 3, there can be formed a recess 31 in which the outcoupling surface 6 of the particular radiation source can engage. Preferably one, particularly discrete, such recess 31 is formed for each radiation source. The recesses can be preformed in the light guide body for example during the fabrication of the light guide, for instance by injection molding.

A refractive index matching material, for instance a silicone gel, can be disposed between the outcoupling surface 6 and the light guide 28, particularly in the clearance that remains in the recess. Reflection losses at the light guide that occur when radiation passes from the recess into the light guide can be reduced in this way. The refractive index matching material advantageously reduces the refractive index mismatch between the material in the recess, for example air, and the material of the light guide or of the optical element. The refractive index matching material preferably has a refractive index that is between that of the material adjoining the outcoupling surface and that of the material of the light guide. Furthermore, the refractive index matching material preferably adjoins the outcoupling surface and the light guide. The clearance can be filled substantially completely with the refractive index matching material.

Omitting the carrier elements and applying any reflector layers 1, 2 and 12 directly to the light guide 28 simplifies the creation of a small and compact illumination device.

FIG. 5 shows a schematic sectional view of a fourth exemplary embodiment of an illumination device according to the invention. The exemplary embodiment of FIG. 5 is substantially the same as that illustrated in FIG. 4. As distinct therefrom, a reflector element 32 is disposed and/or configured on the opposite side of the, particularly of each, recess 31 from the outcoupling surface 6. The cross section of the reflector element 32 preferably tapers from the light guide toward the outcoupling surface. Particularly preferably, the reflector element is arranged symmetrically with respect to the optical axis 231 of the optical element 23. The reflector element 32 can, for example, be coated with a reflection-enhancing material, e.g. a metal. The reflector element 32 preferably has a substantially triangular cross section.

By means of the reflector element, the radiation leaving the radiation source via the outcoupling surface 6 can be distributed in the lateral direction in addition to any beam shaping in the optical element 23. This is illustrated by radiation fraction 84, whose angle with respect to the optical axis 231 is increased by reflection from the reflector element. The impingement area of radiation on the first reflector layer can be increased in this way. A large-area radiant power distribution on the first reflector layer can thus be obtained in a simplified manner.

In addition, the reflector element is preferably spaced apart from the outcoupling surface 6. In this way, radiation fractions whose angle with respect to the optical axis is already sufficiently large can, in a simplified manner, strike the first reflector layer without being reflected by the reflector element.

This patent application claims the priorities of German Patent Applications DE 10 2005 047 154.4 of Sep. 30, 2005, and DE 10 2005 061 208.3 of Dec. 21, 2005, whose entire disclosure content is hereby explicitly incorporated by reference into the present patent application.

The invention is not limited to the exemplary embodiments by the description of it with reference thereto. Rather, the invention encompasses any novel feature and any combination of features, including in particular any combination of features recited in the claims, even if that feature or combination itself is not explicitly mentioned in the claims or exemplary embodiments.

1. An illumination device having a radiation exit surface, a reflector arrangement comprising a first reflector layer and a second reflector layer, and a radiation source, wherein
said first reflector layer is disposed between said radiation exit surface and said radiation source and radiation generated by said radiation source radiates in part through said first reflector layer, and
said second reflector layer is disposed on the opposite side of said first reflector layer from said radiation exit surface.

2. The illumination device as in claim 1,
characterized in that said illumination device is configured to laterally illuminate said radiation exit surface.

3. The illumination device as in claim 1,
characterized in that said illumination device comprises a plurality of radiation sources.

4. The illumination device as in claim 3,
characterized in that said first reflector layer is disposed between said radiation exit surface and said plurality of radiation sources.

5. The illumination device as in claim 1,
characterized in that said first reflector layer is configured to reflect a portion of the radiation generated by said radiation source.

6. The illumination device as in claim 1,
characterized in that said first reflector layer completely covers said second reflector layer in the lateral direction and/or vice versa.

7. The illumination device as in claim 1,
characterized in that said first reflector layer and/or said second reflector layer have/has a reflectivity of 90% or more, preferably of 95% or more, particularly preferably of 98% or more.

8. The illumination device as in claim 1,
characterized in that said first reflector layer and/or said second reflector layer contain/contains a metal or is/are implemented as metallic.

9. The illumination device as in claim 1,
characterized in that the reflectivity of said second reflector layer is higher than the reflectivity of said first reflector layer.

10. The illumination device as in claim 1,
characterized in that an additional reflector layer is disposed on the opposite side of said second reflector layer from said first reflector layer.

11. The illumination device as in claim 1,
characterized in that said first reflector layer and/or said second reflector layer is/are implemented in one piece, particularly as an uninterrupted layer that is reflective throughout.

12. The illumination device as in claim 1,
characterized in that said second reflector layer comprises a gap or a plurality of gaps.

13. The illumination device as in claim 12,
characterized in that said radiation source engages in said gap.

14. The illumination device as in claim 3,
characterized in that a discrete recess is associated with each said radiation source.

15. The illumination device as in claim 1,
characterized in that said radiation source has an outcoupling surface through which radiation generated in said radiation source leaves said radiation source.

16. The illumination device as in claim 15,
characterized in that a distance from said outcoupling surface to said radiation exit surface is 5 mm or less.

17. The illumination device as in claim 15,
characterized in that said outcoupling surface is disposed between said first reflector layer and said second reflector layer.

18. The illumination device as in claim 1,
characterized in that said radiation source is implemented as a radiation emitting diode.

19. The illumination device as in claim 1,
characterized in that radiation generated in said radiation source passes through an optical element before striking said first reflector layer.

20. The illumination device as in claim 3,
characterized in that a respective optical element is associated with each said radiation source.

21. The illumination device as in claim 19,
characterized in that the surface of said optical element comprises on the radiation exit side a concavely curved subregion and a convexly curved subregion that surrounds said concavely curved subregion.

22. The illumination device as in claim 1,
characterized in that said reflector arrangement comprises a side reflector layer and said side reflector layer extends from said first reflector layer to said second reflector layer.

23. The illumination device as in claim 22,
characterized in that by means of said first reflector layer, said second reflector layer and said side reflector layer, a beam space is formed on which the radiant power generated by said radiation source is concentrated.

24. The illumination device as in claim 22,
characterized in that said side reflector layer is disposed against said first and/or said second reflector layer.

25. The illumination device as in claim 22, characterized in that said side reflector layer has a reflectivity of 90% or more.

26. The illumination device as in claim 22, characterized in that the reflectivity of said side reflector layer is higher than the reflectivity of said first reflector layer.

27. The illumination device as in claim 22, characterized in that said side reflector layer contains a metal or is implemented as metallic.

28. The illumination device as in claim 22, characterized in that said side reflector layer is implemented in one piece, particularly as an uninterrupted layer that is reflective throughout.

29. The illumination device as in claim 1,
characterized in that said illumination device is provided for backlighting a display device.
